(19) United States
(12) Patent Application Publication
(10) Pub. No.: US 2017/0369204 A1
(43) Pub. Date: Dec. 28, 2017

(54) GRAVITY ASSISTED PORTABLE FUEL CONTAINER

(71) Applicant: DBH Enterprises, Inc., Newton, MA (US)

(72) Inventors: Mark BERMINGHAM, Windham, NH (US); Erik DIEKMANN, Boston, MA (US)

(21) Appl. No.: 15/534,876

(22) PCT Filed: Dec. 10, 2015
(86) PCT No.: PCT/US15/65018

§ 371 Date: Jun. 9, 2017

Related U.S. Application Data
(60) Provisional application No. 62/090,118, filed on Dec. 10, 2014.

(51) Int. Cl. B65D 25/28; B67D 7/04; B65D 25/42; B67D 7/00; B65D 47/06

(52) U.S. Cl. CPC B65D 25/2811; B67D 7/04; B65D 25/42; B65D 47/06; B67D 7/005

(57) ABSTRACT

A portable fuel container is disclosed that include a bottom side, a top side having a primary handle, and a spout located on a side wall of the container such that the fuel contents of the portable fuel container may be poured using gravity without requiring that the portable fuel container be rotated.

### PRIORITY

The present application claims priority to U.S. Provisional Patent Application Ser. No. 62/090,118 filed Dec. 10, 2014, the disclosure of which is hereby incorporated by reference in its entirety.

### BACKGROUND

The invention generally relates to fuel containers, and more particularly relates to portable fuel containers.

A challenge with portable fuel containers involves how to get fuel out of a portable fuel container without it having to be burdensome, ergonomically awkward and difficult. Current manufacturers have simply built a product to meet U.S. Environmental Protection Agency (EPA) regulations but have not taken into consideration the user, in particular ease of use, and do not provide a product that is built with an ergonomic design perspective.

There remains a need for an innovative portable fuel container that improves the process of displacing fluids from the container into a target appliance, and in particular, improves the user experience by lessening the physical interaction required to expel fluids from the container while retaining the fluid securely as required by today's governmental regulatory mandates.

### SUMMARY

In accordance with an embodiment, the invention provides a portable fuel container including a bottom side, a top side having a primary handle, and a spout located on a side wall of the container such that the fuel contents of the portable fuel container may be poured using gravity without requiring that the user exert rotational force to expel fuel from the container.

In accordance with another embodiment, the invention provides a portable fuel container including a spout that is located on a first side of the portable fuel container, said portable fuel container further including a second side on which the portable fuel container may rest on the ground without obstruction by the spout, and a first handle on a third side of the portable fuel container, the third side being generally opposite the second side of the portable fuel container.

In accordance with a further embodiment, the invention provides a portable fuel container including a first bottom side on which the portable fuel container may rest on a ground without obstruction, a second side that is generally opposite the first side of the portable fuel container, and a spout that is positioned on a third side adjoining the first and second sides, the third side including a lower portion near the first side on which is located a spout.

### BRIEF DESCRIPTION OF THE DRAWINGS

The following description may be further understood with reference to the accompanying drawings in which:

FIG. 1 shows an illustrative diagrammatic view of a fuel container of the prior art;

FIG. 2 shows an illustrative diagrammatic view of a fuel container in accordance with an embodiment of the present invention;

FIG. 3 shows an illustrative diagrammatic view of the fuel container of FIG. 2 positioned to pour liquid from the container;

FIG. 4 shows an illustrative diagrammatic view of the fuel container of FIG. 1 illustrating the movement required to pour liquid from the container;

FIG. 5 shows an illustrative diagrammatic view of the fuel container of FIG. 2 illustrating the required movement to lift the container;

FIGS. 6 and 7 show illustrative diagrammatic views of a fuel container in a storage position accordance with another embodiment of the present invention;

FIGS. 8 and 9 show illustrative diagrammatic side views of the fuel container of FIGS. 6 and 7;

FIGS. 10 and 11 show an illustrative diagrammatic side views of the fuel container of FIGS. 6 and 7 in a second position;

FIG. 12 shows an illustrative diagrammatic spout end view of the fuel container of FIGS. 6 and 7; and

FIG. 13 shows an illustrative diagrammatic rear view of the fuel container of FIGS. 6 and 7.

### DETAILED DESCRIPTION

In accordance with various embodiment, the invention involves moving the location of the egress of a portable fuel container. The current invention relocates the egress and spout location for displacing fluids from a portable fuel container from the top of a container to the bottom of the container (when engaging the current invention for displacing liquids from a container). The location has been moved and is significantly relevant for the initiation of fluid flow operations.

The egress and spout located at the bottom of the portable fuel container leverages gravity to power expelling fluids from the portable fuel container instead of having to apply vertical rotational force to the container to empty its' contents. In this way the user is no longer pouring liquids but has instead created a gravity-reliant innovation that revolutionizes fluid displacements from a portable fuel container.

The invention involves changing the dynamics of expelling fluids from a portable fuel container from requiring both vertical and horizontal forces, to one which only requires horizontal lift and thus the operator simply displaces fluids from a container into the target appliance. This is a much simpler, ergonomic, and more effective solution.

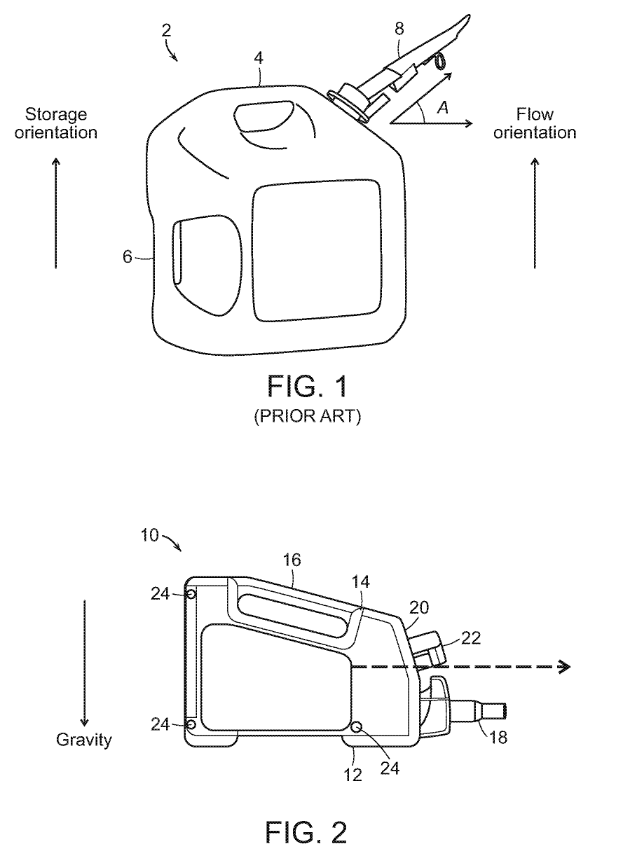

With reference to FIG. 1, and to fully illustrate this significant innovation, it's worthwhile to illustrate and discuss the egress location of a current portable fuel container 2 that includes handles 4 and 6, as well as a spout 8. When viewing the portable fuel container 2 of FIG. 1 from a profile or side view, the egress location is placed at the top of the container. In profile view, consider the container oriented against a circular axis. Conventional portable fuel containers place the spout location at approximately 45 degrees as shown at A in FIG. 1.

With reference to FIG. 2, the invention relocates the egress location to the bottom of the portable fuel container at flow sequence initiation. The spout is oriented on the bottom of the container during the entire act of displacing fuel, from flow initiation through fully expelling all fluids from the container into the target appliance. Expelling fluid from the portable fuel container of FIG. 2 is powered through gravity as opposed to user-applied vertical rotation. The user supplied power of applying vertical force rotation to empty the contents of the container is eliminated. The fluid flow operation process is commenced and powered through gravity.

In particular, the portable fuel container 10 of FIG. 2 includes a bottom side 12, a top side 14 having a primary integrally formed handle 16, and a spout 18 located on a side wall 20 of the container. The spout 18 is preferably located at a position near the bottom side 12, and the top side may be non-parallel with the bottom side, angled downward toward the spout 18. A secondary handle 22 is positioned on the side wall 20, and may be angled with respect to the orientation of the container as shown. This may further facilitate a person pouring fluid from the container.

The portable fuel container 10 of FIG. 2 may further include mating features 24 that facilitate securing multiple containers together, and the features 24 may include recesses on one side of each container, that mate with protrusions on the other side of each container.

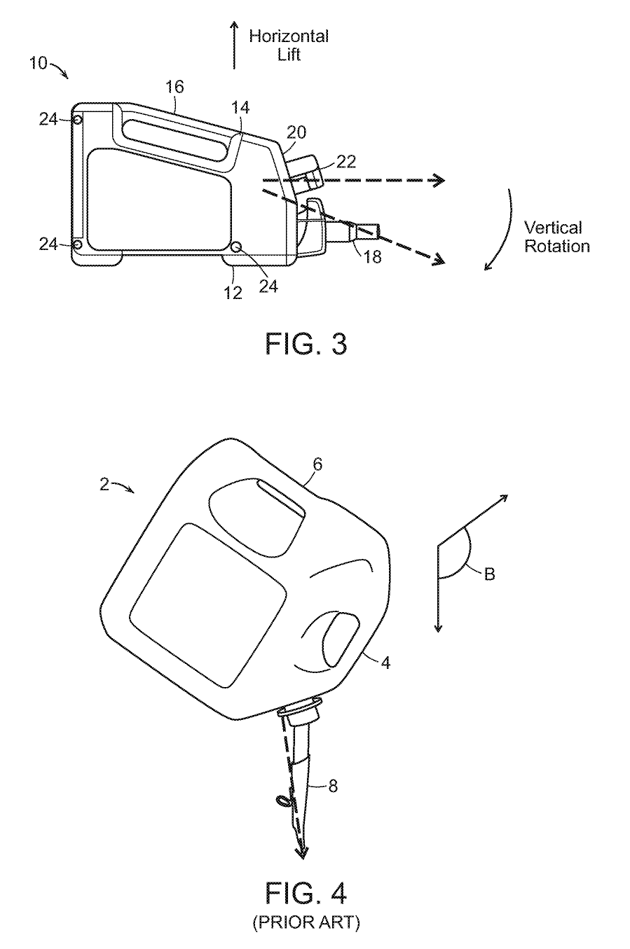

FIG. 3 shows that nearly the entire contents of the portable fuel container may be expelled by the user supplying very little rotational force. As the container has been nearly completely emptied, it is significantly lightened and easier to manipulate and to apply the small vertical rotational force required to completely empty the container. This innovation requires no rotational force to initiate or continue fluid displacement operations until the container has been nearly completely emptied.

By comparison and with reference to FIG. 4, a conventional portable fuel container would require that the container be rotated to begin the liquid transfer process and then continuously rotated from fluid flow initiation possibly up to approximately 170 degrees to fully expel all liquids from the shows as shown at B.

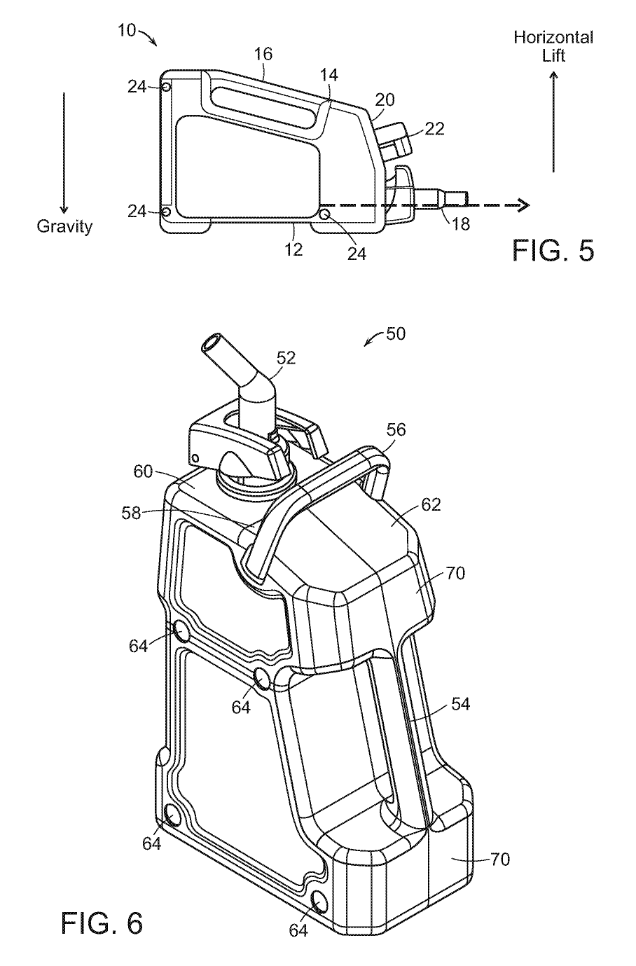

As shown in FIG. 5, fuel containers of certain embodiments of the invention require only that the portable fuel container of an embodiment of the invention be lifted horizontally to begin the process of fluid displacement. This new design ensures that gravity is substituted for operator applied vertical force to initiate and continue the process of displacing liquids from the PFC into the target appliance.

Additionally, the spout 18 may include a spring-actuated seal device that may only permit fluid to leave the container when the spout is securely engaged with another container or tank.

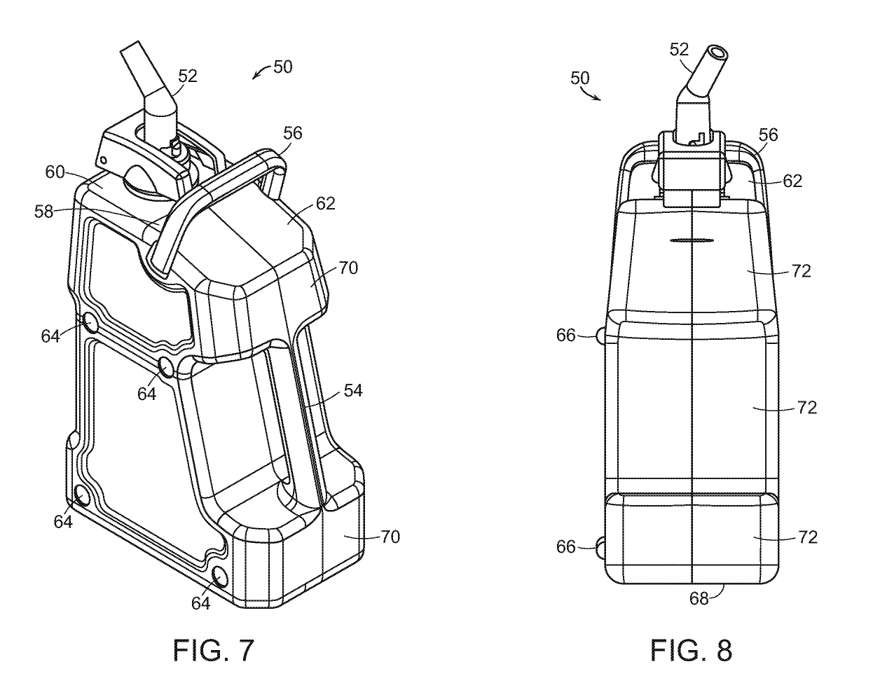

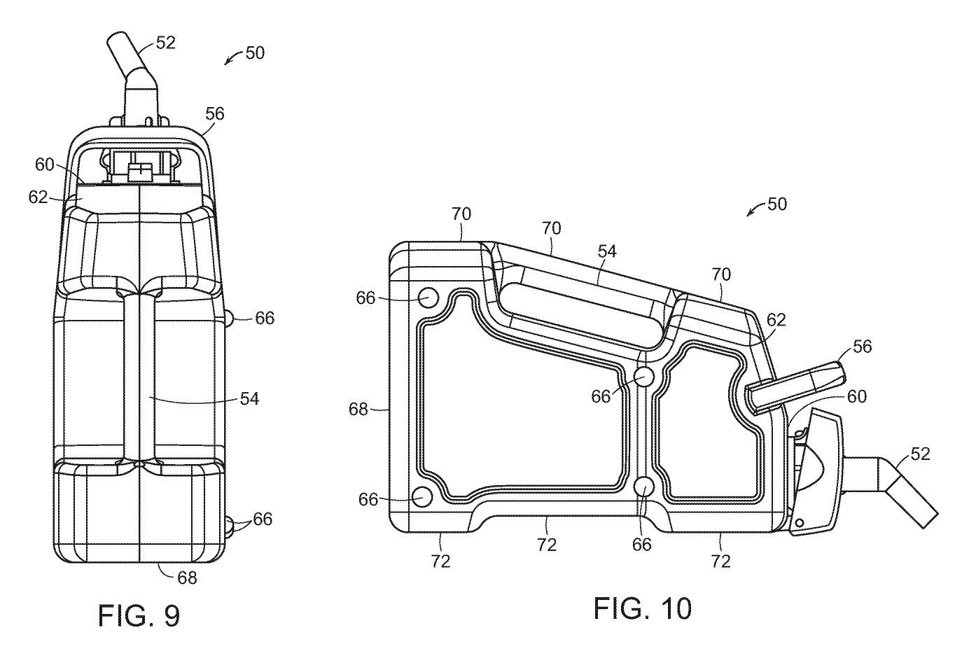

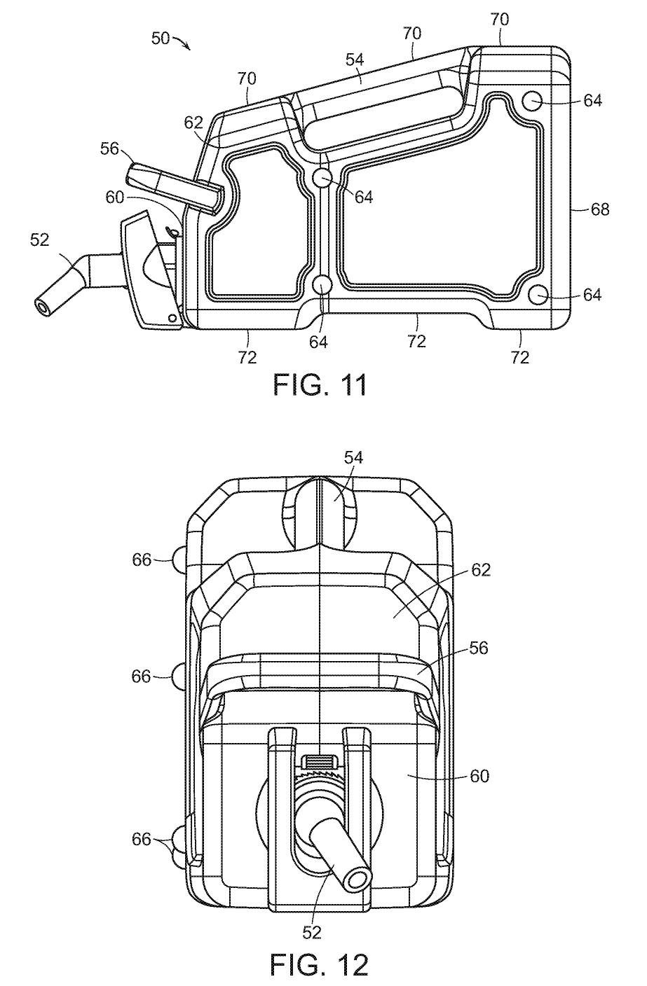

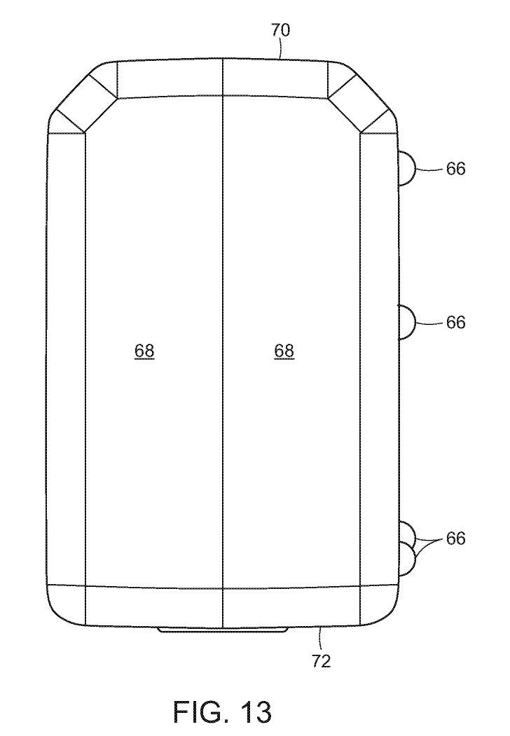

FIG. 6 through FIG. 13 show a portable fuel container 50 in accordance with another embodiment of the present invention. The portable fuel container 50 includes a spout 52 that may swivel and may include a spring-actuated seal device as discussed above. The container 50 is shown in FIGS. 6 through 9 in a storage position and includes an integrally formed primary handle 54 as well as a secondary handle 56 that may assist a user in pouring fluid from the container. The spout 52 is located on a first portion 60 of a side 58, and the side 58 also includes a second portion 62 that includes the secondary handle 56. As shown in FIGS. 7 and 9, the container also includes mating recessed portions 64 and protrusion portions 66 that assist in either stacking or pressing together multiple such portable fuel containers.

Generally opposite the side 58 is a side 68 on which the container may be placed for storage as shown in FIGS. 6 through 9. The primary handle 54 is located on a side 70 that is generally opposite side 72. While the first portion 60 of the side 58 is generally parallel with the side 68, the side 70 is generally not parallel with the side 72.

The portable fuel container 50 of FIGS. 6 through 13 therefore, includes a bottom side (e.g., 72), a top side (e.g., 70) having a primary handle (e.g., 54), and a spout (e.g., 52) located on a side wall (e.g., 58) of the container such that the fuel contents of the portable fuel container may be poured using gravity without requiring that the portable fuel container be rotated. The portable fuel container may also a second handle (e.g., 56) that is positioned in the side wall (e.g., 58) to facilitate stabilizing the portable fuel container during the pouring of fuel from the portable fuel container.

The invention also provides a portable fuel container that includes a spout (e.g., 52) that is located on a first side (e.g., 58) of the portable fuel container, where the portable fuel container further includes a second side (e.g., 72) on which the portable fuel container may rest on the ground without obstruction by the spout. A first handle (e.g., 54) may be provided on a third side (e.g., 70) of the portable fuel container where the third side is generally opposite the second side (e.g., 70) of the portable fuel container.

In accordance with a further embodiment, the portable fuel container may include a first bottom side (e.g., 72) on which the portable fuel container may rest on a ground without obstruction, a second side (e.g., 70) that is generally opposite the first side of the portable fuel container, and a spout (e.g., 52) that is positioned on a third side (e.g., 58) adjoining the first and second sides, the third side including a lower portion (e.g., 60) near the first side on which is located a spout (e.g., 52).

Those skilled in the art will appreciate that numerous modifications and variations may be made to the above disclosed embodiments without departing from the spirit and scope of the present invention.

What is claimed is:

1. A portable fuel container comprising a bottom side, a top side having a primary handle, and a spout located on a side wall of the container such that the fuel contents of the portable fuel container may be poured using gravity without requiring that the user apply rotational force to the portable fuel container to initiate and continue fluid flow operations.

2. The portable fuel container as claimed in claim 1, wherein said portable fuel container further includes a second handle that is positioned in the side wall to facilitate stabilizing the portable fuel container during the pouring of fuel from the portable fuel container.

3. The portable fuel container as claimed in claim 1, wherein said spout is located at a position near the bottom wall.

4. The portable fuel container as claimed in claim 2, wherein said top side is not parallel with the bottom side.

5. The portable fuel container as claimed in claim 1, wherein the primary handle is integrally formed with a housing of the portable fuel container.

6. A portable fuel container comprising a spout that is located on a first side of the portable fuel container, said portable fuel container further including a second side on which the portable fuel container may rest on the ground without obstruction by the spout, and a first handle on a third side of the portable fuel container, said third side being generally opposite the second side of the portable fuel container.

7. The portable fuel container as claimed in claim 6, wherein said third side of the portable fuel container is not parallel with the second side of the portable fuel container.

8. The portable fuel container as claimed in claim 6, wherein said portable fuel container further includes a second handle on the first side of the portable fuel container.

9. The portable fuel container as claimed in claim 6, wherein said spout is located near a corner of the first side and the second side of the portable fuel container.

10. The portable fuel container as claimed in claim 6, wherein said first side of the portable fuel container includes a portion that is generally parallel with a fourth side of the portable fuel container that is generally opposite the first side of the portable fuel container.

11. The portable fuel container as claimed in claim 6, wherein said first handle is integrally formed with an outer housing of the portable fuel container.

12. A portable fuel container comprising a first bottom side on which the portable fuel container may rest on a ground without obstruction, a second side that is generally opposite the first side of the portable fuel container, and a spout that is positioned on a third side adjoining the first and second sides, said third side including a lower portion near the first side on which is located a spout.

13. The portable fuel container as claimed in claim 12, wherein said second side is not parallel with the first side.

14. The portable fuel container as claimed in claim 12, wherein said portable fuel container further includes a second handle on an upper portion of the third side.

15. The portable fuel container as claimed in claim 12, wherein the portable fuel container includes a fourth side that is generally parallel with the lower portion of the third side of the portable fuel container.
